(19) United States
(12) Patent Application Publication
(10) Pub. No.: US 2010/0090496 A1
(43) Pub. Date: Apr. 15, 2010

(54) VEHICLE DRAG REDUCTION METHOD AND APPARATUS

(76) Inventor: James Carlson, El Paso, TX (US)

Correspondence Address: Ortiz and Lopez, PLLC, P.O. Box 4484, Albuquerque, NM, 87196, US

(21) Appl. No.: 12/570,133

(22) Filed: Sep. 30, 2009

Related U.S. Application Data
(60) Provisional application No. 61/104,016, filed on Oct. 9, 2008.

(51) Int. Cl. B62D 35/00

(52) U.S. Cl. 296/180.1

(57) ABSTRACT

A drag reduction method and apparatus for reducing aerodynamic pressure drag associated with a vehicle in motion by use of grit, grit tape, or other turbulator to increase the momentum of boundary layer flow over a vehicle. A turbulator, such as grit tape, can be attached to the smooth external body surface of the vehicle to improve upon a vehicles fuel economy. The turbulator associated with the grit material reduce the effects of the pressure drag by creating a turbulent boundary layer over the surface of the vehicle that moves a separation point from a laminar flow to a turbulent flow backwards along the vehicle. The reduction in pressure drag reduces the overall energy needed to move the vehicle through the air, which improves upon the fuel economy of the vehicle.

### CROSS-REFERENCE TO PROVISIONAL PATENT APPLICATION

This patent application claims priority under 35 U.S.C. §119(e) to U.S. Provisional Patent Application Ser. No. 61/104,016, entitled “Drag Reducing Tape—Grit Tape,” which was filed on Oct. 9, 2009 with the U.S. Patent & Trademark Office. U.S. Provisional Patent Application Ser. No. 61/104,016 is herein incorporated by reference in its entirety.

### TECHNICAL FIELD

Embodiments are generally related to automotive vehicles. Embodiments are also related to techniques for reducing aerodynamic drag imposed on vehicles using grit tape. Embodiments are additionally related to turbulators for reducing aerodynamic drag on vehicles.

### BACKGROUND OF THE INVENTION

Motor vehicles such as, for example, automobiles, sport utility vehicles, cars, and trucks, generally require a propulsive force in order to move the vehicle along the road and through the air. The propulsive force must overcome aerodynamic drag associated with the vehicle in order to move the vehicle forward. Drag is a force that opposes the motion of the vehicle through air. Pressure drag is a particular form of drag that results from a separation of the laminar airflow over the surface of the vehicle, which then transitions to turbulent airflow. The transition from laminar to turbulent airflow creates lower pressure region behind the vehicle compared to the pressure in front of the vehicle. This particular drag force, which the vehicle has to overcome as it moves forward, is called pressure drag.

Typically, when the vehicle is in motion, air flows over the surface of the vehicle. As air moves over the vehicle it begins to slow down along the surface of the vehicle. The distance between the free stream flow of air above the surface of the vehicle and the surface area of the vehicle itself is called the boundary layer. As air flows within the boundary layer, the momentum of the boundary layer flow slows over the length of the surface. The slowing boundary layer loses kinetic energy and an adverse pressure gradient forms within the boundary layer, slowing it down further. A point is reached along the surface of the vehicle where the boundary layer trips the flow of air above from a laminar flow to a turbulent flow. The point at which this transition occurs is called the separation point. Such a turbulent flow behind the vehicle causes a pressure differential that opposes the force moving the vehicle on the road and through the air. The separated flow-fields, thus, cause an increased drag on the vehicle, increased fuel consumption, and an increased level of noise perceived within the interior of the vehicle.

Several approaches have been proposed to reduce the aerodynamic drag of a vehicle by increasing the momentum of the airflow over the vehicle. Such approaches, however, do not the momentum of the boundary layer with passive turbulators. These approaches require an input of additional energy into the aerodynamic flow of air over the vehicle using energy derived from the vehicle itself, which reduces the overall efficiency to save fuel. In one prior art approach ducts may be employed for air flow redirection and electric fans for generating increased airflow with respect to the vehicle. Such an approach requires additional energy from the vehicle's drive train to overcome the aerodynamic drag through the additional ducts and additional energy from the vehicle's electrical system to drive the fan motors. To save energy with this approach one has to add energy from the vehicle. The additional energy applied to the flow of air over a vehicle may positively or adversely affect the performance of the vehicle; but drawing the additional energy from the vehicle reduces the overall improvement to the fuel efficiency of the vehicle.

Another approach to improving vehicle fuel economy requires a turbulator placed underneath the front bumper of a vehicle to manage flow under the vehicle. Such an approach, however, does not prevent boundary layer separation that occurs on the smooth surfaces on the top and sides of the vehicle that creates pressure drag over and about the vehicle.

Based on the foregoing, it is believed that a need exists for an improved method and apparatus for reducing aerodynamic drag associated with a vehicle in motion by increasing a boundary layer momentum. A need also exists for an improved turbulator affixed to the vehicle's smooth external surfaces (e.g., top and sides), as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiment to provide for an improved drag reduction method and apparatus for automotive vehicles.

It is another aspect of the disclosed embodiment to provide for an improved turbulator (e.g., drag reducing grit tape) for reducing aerodynamic drag associated with a vehicle in motion by increasing a boundary layer momentum.

It is a further aspect of the disclosed embodiment to provide for an improved method for configuring the turbulator on the vehicle's external body surface.

The aforementioned aspects and other objectives and advantages can now be achieved as described herein. A drag reduction method and apparatus for reducing aerodynamic drag associated with a vehicle in motion by increasing momentum of a boundary layer is disclosed. Drag reducing grit tape (e.g., a turbulator) can be attached to an external surface of the vehicle (e.g., leading edge of the vehicle roof). This type of turbulator can be formed using packaging tape, glue, and grit. The packaging tape can be aligned on the vehicle roof by stretching a fiber (e.g., string, cord, strand, twine, etc) over the leading edge of the vehicle surface in order to form a straight line. A layer of a packaging tape may be aligned by the fiber and the fiber can be removed once the tape is affixed to the vehicle roof. The edges of the packaging tape may be covered with a pressure sensitive tape (e.g., masking tape) and an adhesive glue can be applied evenly over the packaging tape. A grit material can be then sprinkled on top of the adhesive after removing the masking tape and allowed to dry. The turbulator associated with the grit tape reduces the effects of the pressure drag by creating a turbulent flow within the boundary layer. This adds kinetic energy to the boundary layer and moves the separation point from a laminar flow to a turbulent flow backwards along the vehicle, which reduces the effects of pressure drag on the vehicle.

Optionally, the grit material may be configured directly on the surface of the vehicle without the use of the packaging tape medium in order to place the grit material on the vehicle. The grit material may be of any material composition and includes various sizes of grit such as, for example, a fine grit, a medium grit, and a coarse grit. The grit may also be mixed with a paint element and then applied to the surface of the vehicle to form a turbulator. Further, the pattern of the grit tape may be of any size, geometry, design and/or color. The turbulator increases momentum of the boundary layer flow of air over the vehicle without drawing additional energy from the vehicle to make it work. Energy may be drawn from the free stream flow of air already present over the vehicle, which contacts the turbulator to create turbulence in the boundary layer that flows over the vehicle surface. The turbulent flow in the boundary layer increases the kinetic energy of the boundary layer, reduces the magnitude of the adverse pressure gradient within the boundary layer, and moves the separation point to turbulent airflow over the vehicle further back along the surface of the vehicle. Such an approach reduces the overall drag on a vehicle and lowers the amount of energy required to drive the vehicle along a road thereby improving fuel economy.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle associated with a turbulator for reducing aerodynamic drag, in accordance with the disclosed embodiments;

FIGS. 2-8 illustrate logical operational steps for configuring grit material in association with a packaging tape on the surface of the vehicle, in accordance with the disclosed embodiments;

FIG. 9 illustrates a top view of the vehicle associated with the grit material permanently placed on the surface of the vehicle, in accordance with the disclosed embodiments;

FIG. 10 illustrates a top view of the vehicle associated with the turbulator comprising various sizes of grit material, in accordance with the disclosed embodiments; and

FIG. 11 illustrates a detailed flow chart of operation illustrating logical operation steps of a method for configuring the turbulator on surface of the vehicle, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The disclosed embodiments may be employed to reduce drag associated with a vehicle in motion and to improve the vehicle's fuel economy. The passive drag reduction system described herein can provide a more effective and energy-efficient reduction of drag by increasing momentum of a boundary layer. The drag reduction system may be mounted on the surface of any suitable vehicle such as, for example, trucks, trailers, buses, motorized recreational vehicles, recreational trailers, cube vans, vans, mini-vans, and the like. The vehicle may be propelled by any sort of engine, such as, for example, an internal combustion engine, a natural gas powered vehicle, a fuel cell powered vehicle, a solar-powered vehicle, etc.

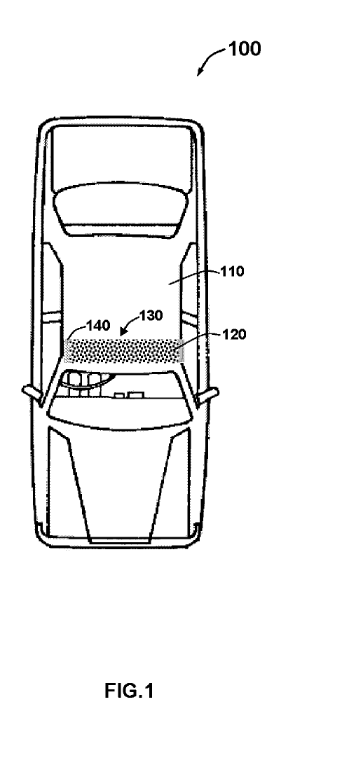

FIG. 1 illustrates a perspective view of a vehicle 100 associated with a grit tape turbulator 130 for reducing aerodynamic pressure drag, in accordance with the disclosed embodiments. Pressure drag occurs when turbulence behind the vehicle 100 forms a lower pressure region with respect to the front of the vehicle 100. This pressure differential between the front and rear of the vehicle 100 opposes the force moving the vehicle 100 on a road and through the air. This pressure differential is called pressure drag. The turbulator 130 may be affixed to an external body surface 110 of the vehicle 100 to reduce the drag by increasing momentum of the boundary layer without introducing addition energy from the vehicle 100 to the airflow over the vehicle 100. For example, the turbulator 130 can be placed on a leading edge of the roof surface 110 of the vehicle 100 where the stream of air flows freely. It can be appreciated that the turbulator 130 can be placed anywhere on the surface of the vehicle without departing from the concept thereof.

The turbulator 130 includes a grit material 120 located on the surface of a packaging tape 140. Note that the grit material 120 may also be placed directly on the surface 110 of the vehicle 100 without the use of the packaging tape 140. The grit is a hard coarse-grained material and may be configured from a material such as, for example, corn cob grit, depending upon design considerations. It can be appreciated that other types of materials may be utilized in place of the suggested material. The energy may be drawn from the free stream flow of air already present over the vehicle 100, which contacts the turbulator 130 to create turbulence in the boundary layer that flows over the vehicle 100. As the boundary layer flow is turned from a laminar flow to a turbulent flow, this increases the momentum of the boundary layer flow of air over the vehicle 100 without adding any energy from the vehicle 100.

The turbulator 130 may be placed as a dimpled impression on the roof surface 110 of the vehicle 100. The turbulator 130 may therefore effectively reduce the aerodynamic drag associated with the vehicle 100 by increasing the boundary layer momentum thereby improving fuel efficiency of the vehicle 100. As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

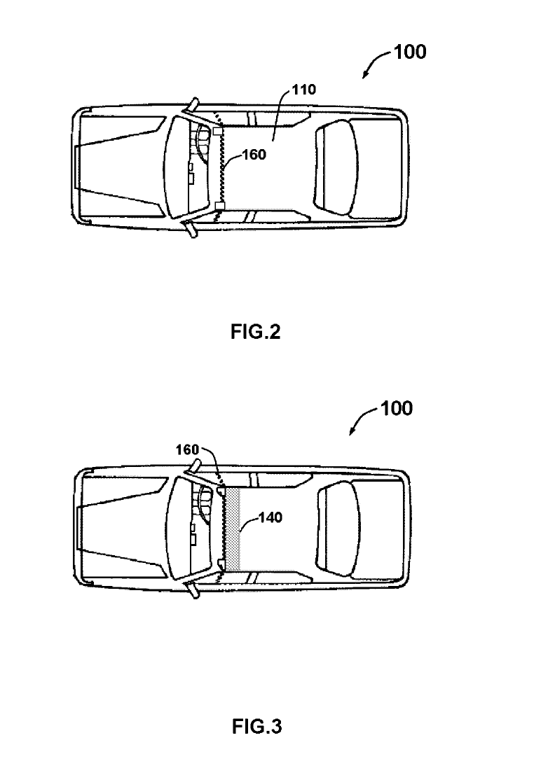

FIGS. 2-8 illustrate logical operation steps for configuring the grit material 120 in association with the packaging tape 140 on the surface 110 of the vehicle 100, in accordance with the disclosed embodiments. Note that in FIGS. 1-11, identical or similar parts are generally indicated by identical reference numerals. The roof surface 110 associated with the vehicle 100 just above a windshield can be cleaned with a clean rag utilizing a solution, such as, for example, isopropyl alcohol. A fiber 160 may be placed onto the surface 110 of the vehicle 100, as depicted in FIG. 2. The fiber 160 may be stretched over a curved surface on the leading edge of the roof surface 110 in order to form a straight line. A bottom edge of the packaging tape 140 may be placed over the fiber 160 and stretched, as illustrated in FIG. 3.

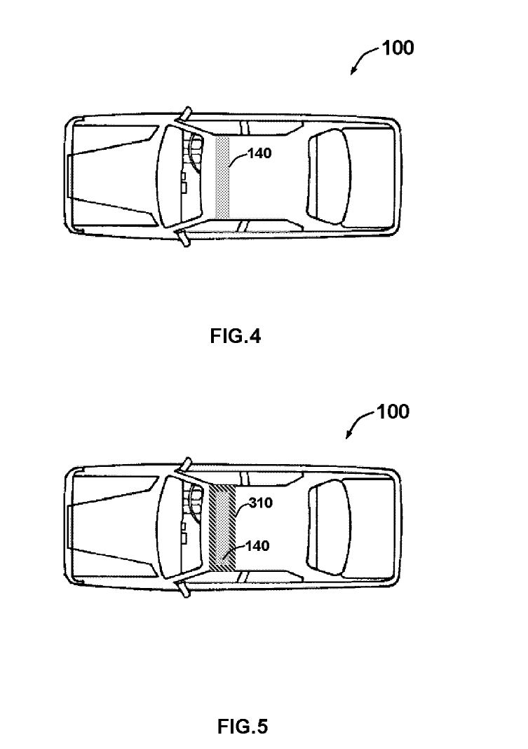

The fiber 160 may be employed to locate the packaging tape 140 across the leading edge of the roof surface 110 in a straight line. The fiber 160 may be then removed and the packaging tape 140 may be left on the roof surface 110 of the vehicle 100, as shown in FIG. 4. Note that the packaging tape 140 described herein may be an ordinary tape that may be employed for various sealing purposes. The air bubbles formed while placing the packaging tape 140 over the fiber 160 may be removed. The edges of the packaging tape (top, bottom and the adjacent sides) 140 may be masked with a masking tape 310, as depicted in FIG. 5.

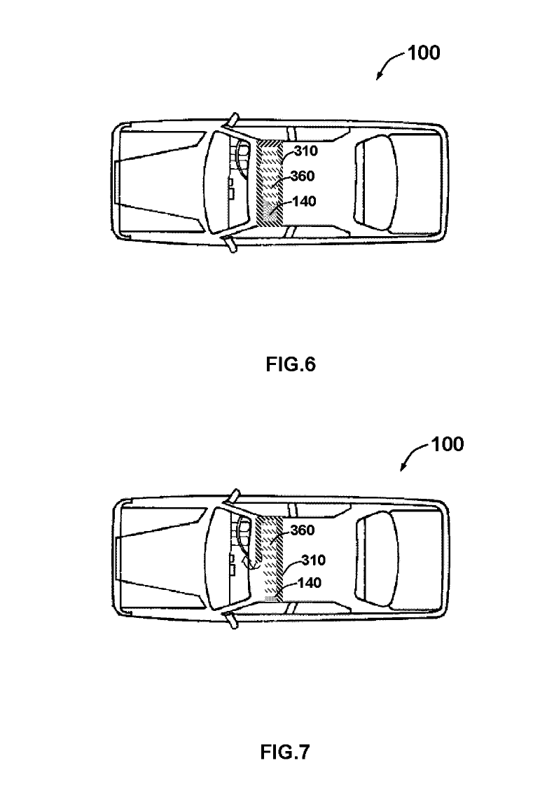

FIG. 6 illustrates a perspective view of the vehicle 100 associated with the masking tape 310 and an adhesive 360, in accordance with the disclosed embodiments. The adhesive 360 may be applied as a thin film across the packaging tape 140 utilizing a spatula (e.g., plastic). The masking tape 310 prevents the adhesive (e.g., glue) 360 from drying on the surface 110 of the vehicle 100. The masking tape 310 may be then removed elegantly after applying the adhesive 360 onto the packaging tape 210, as illustrated in FIG. 7. The masking tape 310 described herein may be configured from a pressure sensitive tape made of a thin and easy-to-tear paper, and an easily released pressure sensitive adhesive. The masking tape 310 may be employed to mask the surface 110 of the vehicle 100 with respect to the adhesive 360. The adhesive of the masking tape 310 permits the masking tape 310 to be easily removed without leaving residue or damaging the roof surface 110 of the vehicle 100 to which it is applied.

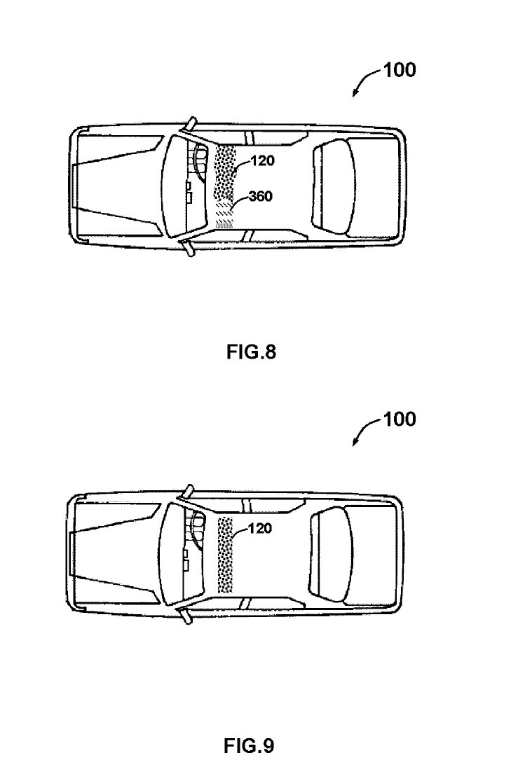

FIG. 8 illustrates a top view of the vehicle 100 associated with the grit material 120 sprinkled on the surface of the adhesive 360, in accordance with the disclosed embodiments. The grit material 120 can be sprinkled over the adhesive before the adhesive 360 is dried. The adhesive 360 provides a secure means for holding the grit material 120 on the surface of the vehicle 100. The edges of the packaging tape 140 may be then trimmed utilizing a knife.

FIG. 9 illustrates a top view of the vehicle 100 associated with the grit material 120 permanently placed on the surface of the vehicle 100, in accordance with the disclosed embodiments. The grit material 120 may be configured directly on the surface of the vehicle 100 without the use of the packaging tape 140 in order to permanently place the grit material 120 on the vehicle 100. The turbulator 130 can be placed in conjunction with the leading edge of the vehicle 100 to reduce the aerodynamic drag. Because the drag is reduced, the cruise efficiency, fuel economy and performance can all be increased while the amount of interior noise can be decreased.

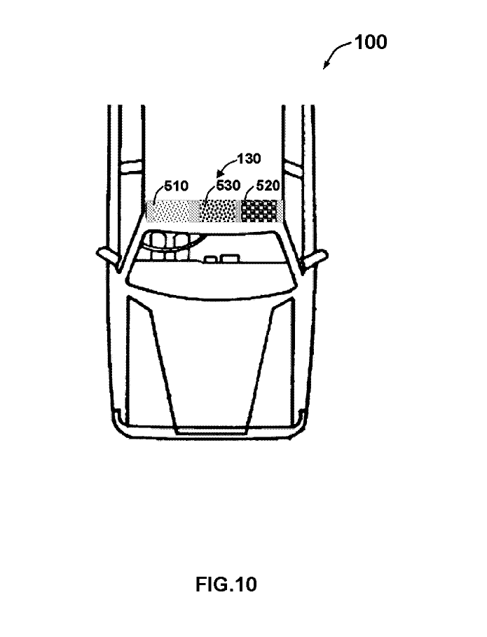

FIG. 10 illustrates a top view of the vehicle 100 associated with the turbulator 130 comprising various sizes of grit material 120, in accordance with the disclosed embodiments. The texture associated with the grit material 120 may include a fine grit 510, a coarse grit 520 and a medium grit 530. The grit material 120 may be affixed to the external surface of the vehicle 100 utilizing any kind of adhesive 360. The grit material 120 may effectively reduce the drag by pushing the separation point backwards with respect to the surface of the vehicle 100 without utilizing any external energy source.

The grit material 120 may even mixed in association with a paint element and then applied to the vehicle 100. The pattern of the packaging tape 140 associated with the grit material 120 may be of any size, geometry, design and/or color. These material size, geometry, design and/or color are described for purposes of clarity and specificity; however, they should not be interpreted as limiting features of the disclosed invention. Other specifications and parameters are possible. It will be apparent, however, to those of skill in the art that such specifications and parameters can be altered without departing from the scope of the invention.

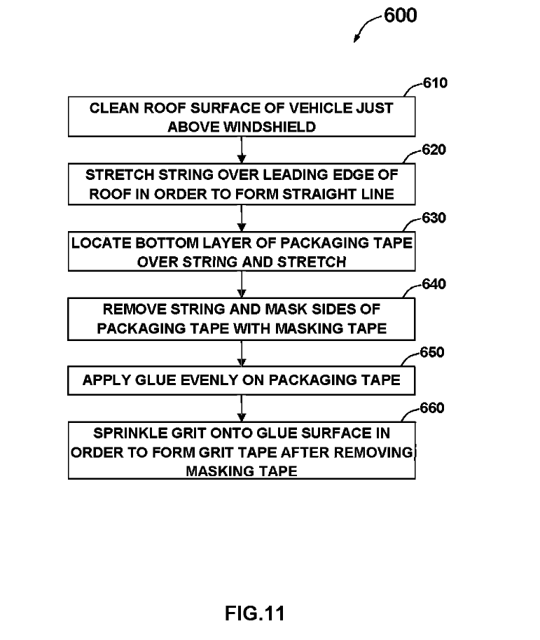

FIG. 11 illustrates a detailed flow chart of operation illustrating logical operation steps of a method 600 for placing the turbulator 130 on the surface 110 of the vehicle 100, in accordance with the disclosed embodiments. Again as reminder, in FIGS. 1-11, identical or similar parts are generally indicated by identical reference numerals. The roof surface 110 of the vehicle 100 can be cleaned with a rag utilizing a solution, as depicted at block 610. The fiber 160 may be stretched over the leading edge in order to form a straight line with respect to the roof surface 110 of the vehicle 100, as indicated at block 620. The bottom layer of the packaging tape 140 may be placed over the fiber 160 and stretched, as depicted at block 630. Thereafter, the fiber 160 may be removed from the roof surface 110 and the sides of the packaging tape 140 may be masked with the masking tape 310, as illustrated at block 640.

The adhesive 360 may be applied evenly on the packaging tape 140, as indicated at block 650. Finally, the masking tape 310 may be removed from the roof surface 110 and the grit can be sprinkled onto the adhesive, as illustrated at block 650. The edges of the packaging tape 140 may then be trimmed to form the turbulator 120. The turbulator 120 increases momentum of the boundary layer flow of air over the vehicle 100 without adding additional energy from the vehicle 100 as the boundary layer flow is turned from laminar to turbulent flow. Energy may be drawn from the free stream flow of air already present over the vehicle 100, which contacts the turbulator 120 to create turbulence in the boundary layer that flows over the vehicle 100. The magnitude of drag reduction depends upon the weather conditions such as temperature and humidity of the air and the speed at which the vehicle travels or relative air speed. Such an approach reduces the overall drag and lowers the amount of energy required to drive the vehicle along a road thereby improving fuel economy.

Based on the foregoing, it can be appreciated that a drag reduction method and apparatus is disclosed for reducing aerodynamic pressure drag associated with a vehicle in motion by use of grit, grit tape, or other turbulator to increase the momentum of boundary layer flow over a vehicle. A turbulator, such as grit tape, can be attached to the smooth external body surface of the vehicle to improve upon a vehicle's fuel economy. One method of applying grit tape to the vehicle surface begins by stretching a fiber over the surface in order to form a straight line. A bottom layer of a packaging tape may be placed over the fiber and the fiber then removed. The edges of the packaging tape may be covered with a masking tape, and an adhesive can be applied evenly over the packaging tape. A grit material can be then sprinkled on top of the adhesive after removing the masking tape and then dried.

The turbulator associated with the grit material reduces the effects of the pressure drag by creating a turbulent boundary layer over the surface of the vehicle that moves a separation point from a laminar flow to a turbulent flow backwards along the vehicle. The reduction in pressure drag reduces the overall energy needed to move the vehicle through the air, which improves upon the fuel economy of the vehicle. This method of improving the fuel economy of the vehicle has been tested and proven successful. The application of grit tape or other similar turbulators to any vehicle will significantly reduce the consumption of fuel, save money spent on fuel, and improve our ability to become energy independent.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for reducing pressure drag on a vehicle, comprising:
applying a grit material on a leading edge of a roof of said vehicle, wherein said grit material in a presence of a free flow of air over said vehicle creates a turbulent boundary layer over a surface of said vehicle that energizes said boundary layer and effectively moves a separation point from a laminar flow to a turbulent flow backwards along said vehicle to thereby reduce effects of pressure drag associated with said vehicle.

2. The method of claim 1 further comprising:
applying said grit material onto a smooth exterior surface of said vehicle, avoiding rough surfaces under said vehicle.

3. The method of claim 1 further comprising:
applying said grit material onto a smooth exterior surface of said vehicle with a turbulator.

4. The method of claim 3 wherein said turbulator comprises a medium of tape.

5. The method of claim 1 further comprising:
applying said grit material in varying geometric patterns onto a smooth exterior surface of said vehicle.

6. The method of claim 1 further comprising:
applying said grit material, mixed with paint, onto a smooth exterior surface of said vehicle.

7. The method of claim 1, further comprising:
applying turbulators of varying compositions onto a smooth exterior surface of said vehicle to assist in reducing said effects of pressure drag associated with said vehicle.

8. The method of claim 1 further comprising
applying dimpled impressions onto said smooth exterior surface of said vehicle to assist in reducing said effects of pressure drag associated with said vehicle.

9. An apparatus for reducing pressure drag on a vehicle, said apparatus comprising:
a grit material, wherein said grit material is applicable to a leading edge of said roof of said vehicle, wherein said grit material in a presence of a free flow of air over said vehicle creates a turbulent boundary layer over a surface of said vehicle that energizes said turbulent boundary layer and effectively moves a separation point from a laminar flow to a turbulent flow backwards along said vehicle to thereby reduce effects of pressure drag associated with said vehicle.

10. The apparatus of claim 9 wherein said grit material is applicable onto a smooth exterior surface of said vehicle, while avoiding rough surfaces under said vehicle.

11. The apparatus of claim 10 further comprising a turbulator, wherein said grit material is applicable onto a smooth exterior surface of said vehicle with turbulator.

12. The apparatus of claim 11 wherein said turbulator comprises a medium of tape.

13. The apparatus of claim 10 wherein said grit material is applicable in varying geometric patterns onto a smooth exterior surface of said vehicle.

14. The apparatus of claim 10 further comprising a mixture of said grit material and a paint, wherein said mixture is applicable onto said smooth exterior surface of said vehicle.

15. The apparatus of claim 10 further comprising a plurality of turbulators of varying compositions, wherein said plurality of turbulators is applicable onto a smooth exterior surface of said vehicle to assist in reducing said effects of pressure drag associated with said vehicle.

16. The method of claim 10 further comprising a plurality of dimpled impressions configured onto said smooth exterior surface of said vehicle to assist in reducing said effects of pressure drag associated with said vehicle.

17. An apparatus for reducing pressure drag on a vehicle, said apparatus comprising:
a turbulator; and
a grit material, wherein said grit material is applicable with said turbulator to a leading edge of said roof of said vehicle, wherein said grit material in a presence of a free flow of air over said vehicle creates a turbulent boundary layer over a surface of said vehicle that energizes said turbulent boundary layer and effectively moves a separation point from a laminar flow to a turbulent flow backwards along said vehicle to thereby reduce effects of pressure drag associated with said vehicle.

18. The apparatus of claim 17 wherein said turbulator comprises a grit tape.

19. The apparatus of claim 17 wherein said grit material is applicable in varying geometric patterns onto a smooth exterior surface of said vehicle.

20. The apparatus of claim 17 further comprising a mixture of said grit material and a paint, wherein said mixture is applicable onto said smooth exterior surface of said vehicle.
